(19) United States
(12) Patent Application Publication
(10) Pub. No.: US 2020/0195332 A1
(43) Pub. Date: Jun. 18, 2020

(54) METHOD OF PERFORMING BEAM REPORTING AND USER EQUIPMENT

(71) Applicant: NTT DOCOMO, INC., Tokyo (JP)

(72) Inventors: Yuichi Kakishima, Tokyo (JP); Chongning Na, Tokyo (JP); Min Liu, Tokyo (JP); Satoshi Nagata, Tokyo (JP)

(73) Assignee: NTT DOCOMO, INC., Tokyo (JP)

(21) Appl. No.: 16/603,037

(22) PCT Filed: Apr. 4, 2018
(86) PCT No.: PCT/US2018/026007

§ 371 Date: Oct. 4, 2019

Related U.S. Application Data
(60) Provisional application No. 62/481,520, filed on Apr. 4, 2017.

(51) Int. Cl. H04B 7/06; H04B 7/08; H04W 16/28; H04L 5/00; H04W 8/24

(52) U.S. Cl. CPC H04B 7/0695; H04B 7/088; H04W 8/24; H04L 5/0051; H04W 16/28

(57) ABSTRACT

A method of performing beam reporting in a wireless communication system is disclosed including receiving, with a user equipment (UE), multiple Transmission (Tx) beams used for transmission of reference signals (RSs) from a base station (BS), and performing, with the UE, first beam reporting to the BS. The first beam reporting indicates the Tx beams divided into groups based on a first predetermined grouping type. When the receiving simultaneously receives first Tx beams of the multiple Tx beams, the first Tx beams are divided into a same group based on the first predetermined grouping type. When the receiving simultaneously receives first Tx beams of the multiple Tx beams, the first Tx beams are divided into different groups based on the first predetermined grouping type.

### TECHNICAL FIELD

The present invention generally relates to a method of beam reporting in a wireless communication system including a base station and a user equipment.

### BACKGROUND

In Third Generation Partnership Project (3GPP), beam reporting schemes for New Radio (NR; fifth generation (5G) radio access technology) are being studied to achieve efficient scheduling in a multi-beam system.

With analog beamforming structure assumed by a wireless transmission system, especially for high frequency bands, analog beams are formed for transmitting signals from a base station (BS) and receiving signals at a user equipment (UE) or vice versa. Multiple analog beams associated to a common Radio Frequency (RF) chain cannot be used simultaneously due to hardware implementations. For such a wireless transmission system, the BS and the UE may be required to establish multiple transmission (Tx) and reception (Rx) beam pairs for control and data signals transmission. In such a wireless transmission system, a beam training procedure is typically assumed where the number of K Tx beams and the number of L Rx beams are measured to identify the appropriate Tx/Rx beam pairs. However, as described above, among the L Rx beams, not all beams can be simultaneously received at the UE. The UE may be required to transmit, to the BS, feedback information indicating use of Rx beams that cannot be used simultaneously, to avoid using Tx beams simultaneously. On the other hand, transmission of explicit indication of beams that can be and cannot be simultaneously received may incur large feedback overhead.

### CITATION LIST

### Non-Patent Reference

[Non-Patent Reference 1] 3GPP, TS 36.211 V 14.1.0
[Non-Patent Reference 2] 3GPP, TS 36.213 V14.1.0

### SUMMARY

One or more embodiments of the present invention relate to a method of performing beam reporting in a wireless communication system. The method includes receiving, with a user equipment (UE), multiple Transmission (Tx) beams used for transmission of reference signals (RSs) from a base station (BS), and performing, with the UE, first beam reporting to the BS. The first beam reporting indicates the Tx beams divided into groups based on a first predetermined grouping type.

One or more embodiments of the present invention relate to a user equipment (UE) that includes a receiver that receives multiple Transmission (Tx) beams used for transmission of reference signals (RSs) from a base station (BS), and a transmitter that performs, first beam reporting to the BS. The first beam reporting indicates the Tx beams divided into groups based on a first predetermined grouping type.

One or more embodiments of the present invention relate to a beam reporting method that includes performing, with a user equipment (UE), beam reporting based on grouping of reported Transmission (Tx) beams in multiple stages, to a base station (BS).

One or more embodiments of the present invention relate a method that includes transmitting, from the UE to the BS, all necessary information indicating how to efficiently utilize multiple transmit beams. As a result, the UE can receive multiple beams simultaneously.

According to one or more embodiments of the present invention, by defining beam grouping types, different types can be used in different scenarios, which may optimize balance between performance and overhead. Additionally, by defining a multi-stage beam reporting scheme, the feedback overhead can be further reduced.

One or more embodiments of the present invention can provide a method to cause the UE to transmit all necessary feedback information indicating whether Tx/Rx beam pairs can be used simultaneously, with moderate feedback overhead.

Other embodiments and advantages of the present invention will be recognized from the description and figures.

### BRIEF DESCRIPTION OF THE DRAWINGS

FIG. 1 is a diagram showing a configuration of a wireless communication system according to one or more embodiments of the present invention.

FIGS. 2A and 2B are diagrams showing examples of configurations of a TRP(s) 20 and a UE 10 according to one or more embodiments of the present invention.

FIG. 3 is a sequence diagram showing an operation of beam reporting according to one or more embodiments of the present invention.

FIG. 4A is a table showing an example of beam information in beam reporting for beam grouping type “Type 1” according to one or more embodiments of the present invention.

FIG. 4B is a table showing an example of beam information in beam reporting for beam grouping type “Type 2” according to one or more embodiments of the present invention.

FIG. 4C is a table showing an example of beam information in beam reporting for beam grouping type “Type 5” according to one or more embodiments of the present invention.

FIG. 4D is a table showing an example of beam information in beam reporting for beam grouping type “Type 6” according to one or more embodiments of the present invention.

FIG. 5 is a sequence diagram showing an example of an operation of multi-stage beam group reporting according to one or more embodiments of the present invention.

FIG. 6 is a sequence diagram showing another example of an operation of multi-stage beam group reporting according to one or more embodiments of the present invention.

FIG. 7 is a sequence diagram showing an example of an operation of beam reporting according to one or more embodiments of the present invention.

FIG. 8 is a sequence diagram showing an example of an operation of beam reporting according to one or more embodiments of the present invention.

FIG. 9 is a table showing an example of an indication from a TRP and beam reporting from a UE according to one or more embodiments of a second example of the present invention.

FIG. 10 is a table showing an example of an indication from a TRP and beam reporting from a UE according to one or more embodiments of a third example of the present invention.

FIG. 11 is a table showing an example of an indication from a TRP and beam reporting from a UE according to one or more embodiments of a fourth example of the present invention.

FIG. 12 is a diagram showing a schematic configuration of the TRP according to one or more embodiments of the present invention.

FIG. 13 is a diagram showing a schematic configuration of the UE according to one or more embodiments of the present invention.

### DETAILED DESCRIPTION

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

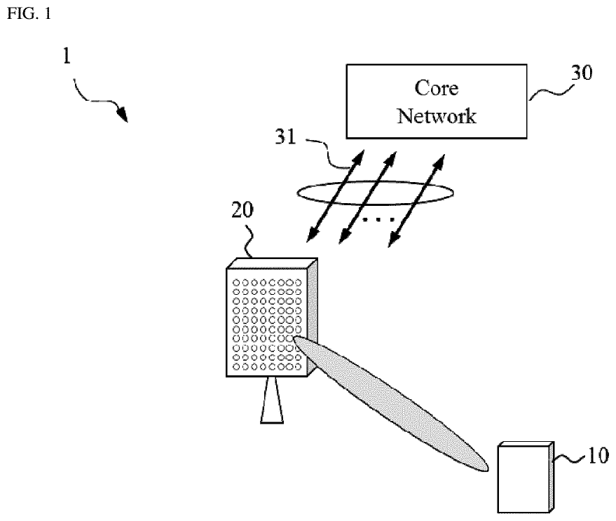

FIG. 1 is a wireless communications system 1 according to one or more embodiments of the present invention. The wireless communication system 1 includes a user equipment (UE) 10, a transmission and a reception point (TRP) 20, and a core network 30. The wireless communication system 1 may be a New Radio (NR) system. The wireless communication system 1 may be a multi-beam system where the TRP 20 and the UE 10 communicate with each other using multiple beams. The wireless communication system 1 is not limited to the specific configurations described herein and may be any type of wireless communication system such as an LTE/LTE-Advanced (LTE-A) system.

The TRP 20 may communicate uplink (UL) and downlink (DL) signals with the UE 10 in a cell of the TRP 20. The DL and UL signals may include control information and user data. The TRP 20 may communicate DL and UL signals with the core network 30 through backhaul links 31. The TRP 20 may be referred to as a base station (BS). The TRP 20 may be gNodeB (gNB).

The TRP 20 includes antennas, a communication interface to communicate with an adjacent TRP 20 (for example, X2 interface), a communication interface to communicate with the core network 30 (for example, S1 interface), and a CPU (Central Processing Unit) such as a processor or a circuit to process transmitted and received signals with the UE 10. Operations of the TRP 20 may be implemented by the processor processing or executing data and programs stored in a memory. However, the TRP 20 is not limited to the hardware configuration set forth above and may be realized by other appropriate hardware configurations as understood by those of ordinary skill in the art. Numerous TRPs 20 may be disposed so as to cover a broader service area of the wireless communication system 1.

The UE 10 may communicate DL and UL signals that include control information and user data with the TRP 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the TRP 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

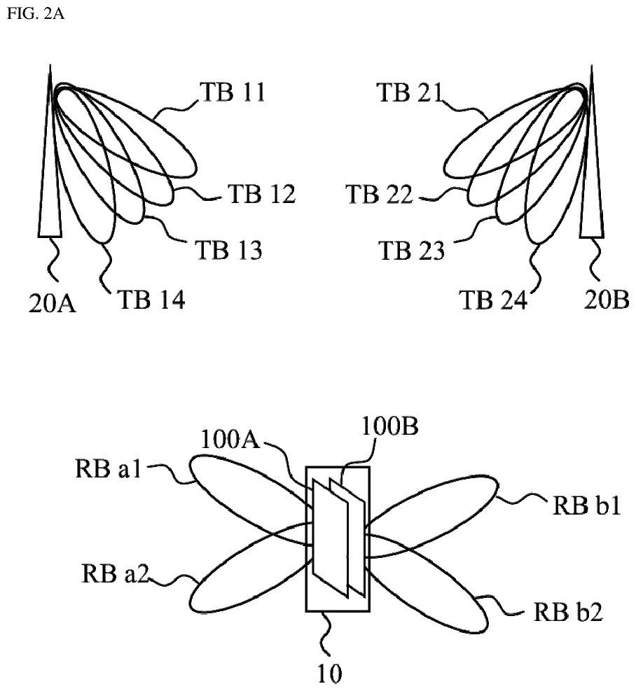

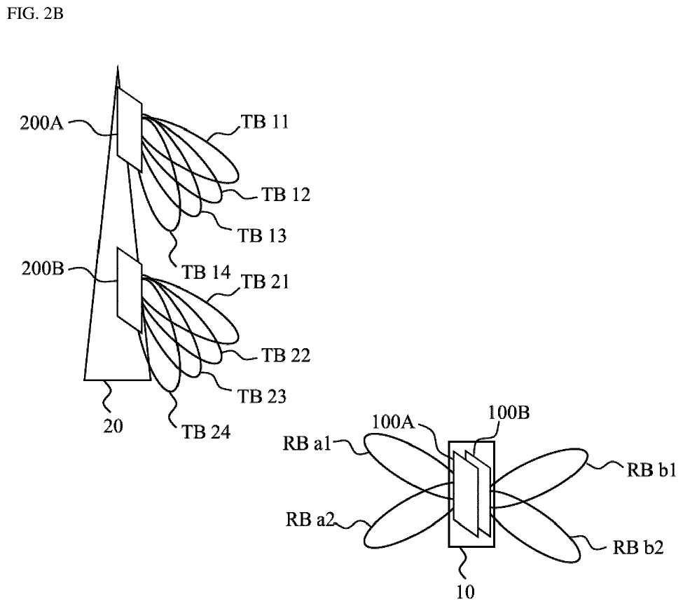

FIGS. 2A and 2B are diagrams showing examples of configurations of the TRP(s) 20 and the UE 10 according to one or more embodiments of the present invention.

According to one or more embodiments, as shown in FIG. 2A, the wireless communication system 1 includes the TRPs 20A and 20B and the UE 10. The TRPs 20A and 20B may transmit multiple downlink signals using multiple Tx beams (TBs) 11-14 and 21-24, respectively. Each of the multiple downlink signals may be transmitted using each of the multiple TBs. The UE 10 receives downlink signals from the TRPs 20A and 20B using multiple Rx beams (RBs). In an example of FIGS. 2A and 2B, the UE 10 includes multiple panels 100A and 100B and receives downlink signals using an RB a1 and an RB a2 associated with the panel 100A and an RB b1 and an RB b2 associated with the panel 100B.

As shown in FIG. 2B, for example, the TRP 20 includes multiple panels 200A and 200B and transmits downlink signals using the TBs 11-14 associated with the panel 200A and the TBs 21-24 associated with the panel 200B.

According to one or more embodiments, multiple beams from different TRPs 20, panels 200 of the TRP 20, or TXRU may be simultaneously transmitted. In examples of FIGS. 2A and 2B, for example, the TB11 and the TB21 may be simultaneously transmitted.

On the other hand, in one or more embodiments, multiple beams from the same panel 200 or TXRU cannot be simultaneously transmitted. In examples of FIGS. 2A and 2B, for example, the TB11 and the TB12 cannot be transmitted simultaneously.

According to one or more embodiments, multiple beams from different Panel/TXRU may be simultaneously used for reception of downlink signals. In examples of FIGS. 2A and 2B, for example, the RBa1 and RBb1 may be simultaneously used for reception of the downlink signals.

On the other hand, in one or more embodiments, multiple beams from same TXRU cannot be simultaneously used for reception of the downlink signals. In examples of FIGS. 2A and 2B, for example, the RBa1 and the RBa2 cannot simultaneously used for reception of the downlink signals.

In one or more embodiments, the numbers of TBs in each TRP 20 or each panel 200A (or 200B) may be a predetermined number that is at least one. The numbers of RBs in each panel 100A (or 100B) may be a predetermined number that is at least one. The number of panels 200 of the TRP 20 is not limited to two and may be at least one. The number of panels 100 of the UE 10 is not limited to two and may be at least one.

Beam reporting schemes according to one or more embodiments of the present invention will be described below using the configuration of FIG. 2A. Furthermore, one or more embodiments of the present invention may be applied to configurations in FIGS. 2A and 2B.

In one or more embodiments, the TBs 11-14 and the TBs 21-24 may be divided into “set 1” and “set 2,” respectively. The RBs a1-a2 and the RBs b1-b2 may be divided into “set a” and “set b,” respectively.

For efficient scheduling in a multi-beam system, the TRP 20 may be required to specify which beams can be received by the UE 10 simultaneously. In conventional technologies, multiple beams cannot be received simultaneously due to the hardware implementation.

On the other hand, according to one or more embodiments of the present invention, using beam reporting mechanism, the UE 10 may be able to explicitly inform the TRP 20 of feasibility of simultaneous reception of multiple TBs.

Furthermore, according to one or more embodiments of the present invention, multiple beam grouping types may be defined, making different assumptions whether beams in the same group or across different groups can be received simultaneously.

For example, in one or more embodiments of the present invention, UE feedback schemes may be designed to report the type of the grouping and details for each beam and the grouping information. Furthermore, BS configuration schemes may be designed to inform the grouping type or types assumed for beam reporting from the UE 10 of the type of the grouping and details for each beam and the grouping information.

Furthermore, in one or more embodiments, a multi-stage feedback scheme may be performed. Compared to a single-stage feedback in the conventional technologies, the multi-stage feedback scheme can further improve the flexibility and reduce the feedback overhead.

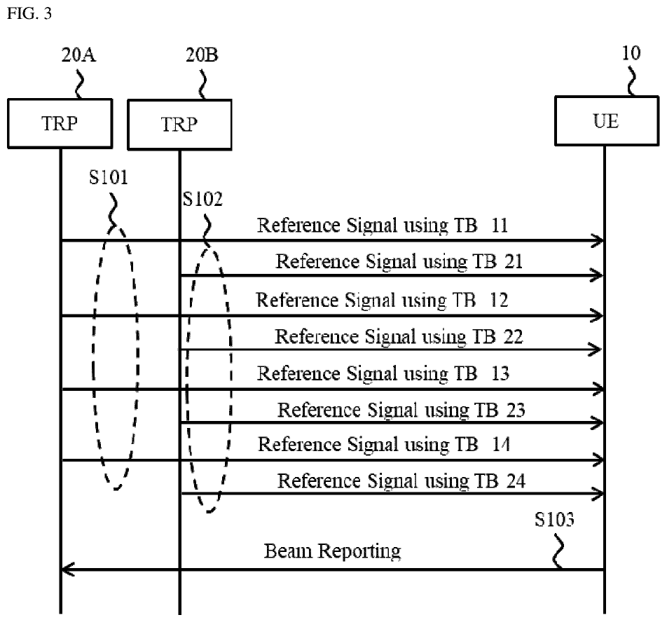

FIG. 3 is a sequence diagram showing an operation of beam reporting according to one or more embodiments of the present invention.

As shown in FIG. 3, at step S101, the TRP 20A may transmit multiple Reference Signals (RSs) using multiple TBs (e.g., TBs 11-14). The RS may be a Channel State Information-Reference Signal (CSI-RS).

At step S102, the TRP 20B may transmit multiple RSs using multiple TBs (e.g., TBs 21-24).

At step S103, in response to the UE 10 receiving the TBs from the TRPs 20A and 20B, the UE 10 may perform, to the TRP 20A, beam reporting that indicates beam information generated based on a beam grouping type. The beam reporting may be transmitted to at least one of the TRPs 20A and 20B. Furthermore, the beam reporting may be performed as CSI reporting including Rank Indicator (RI), CSI-RS resource indicator (CRI), Precoding Matrix Indicator (PMI), Channel Quality Indicator (CQI), and/or Reference Signal Received Power (RSRP).

According to one or more embodiments of the present invention, Type 1 to Type 6 may be introduced as the beam grouping type.

(Type 1)

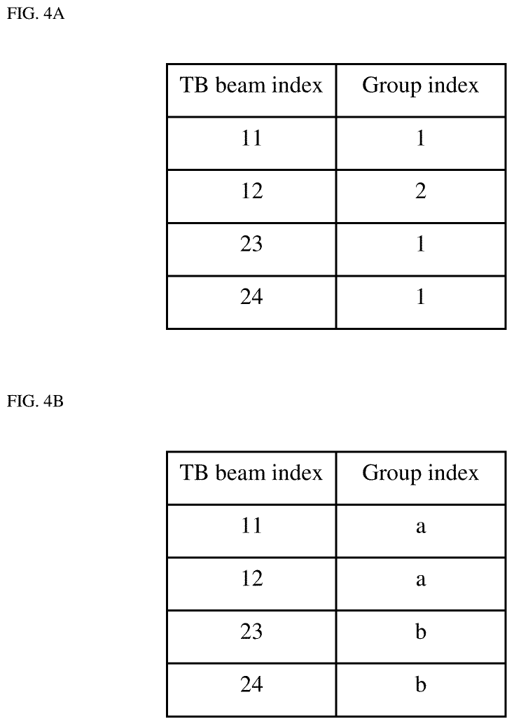

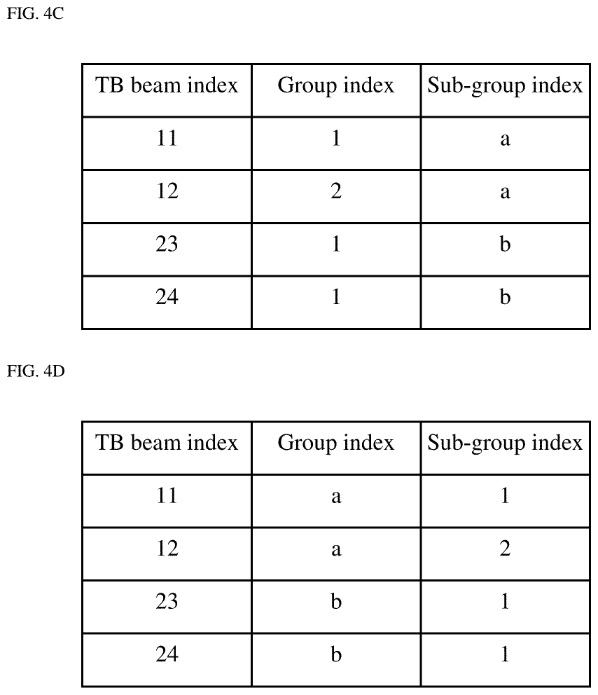

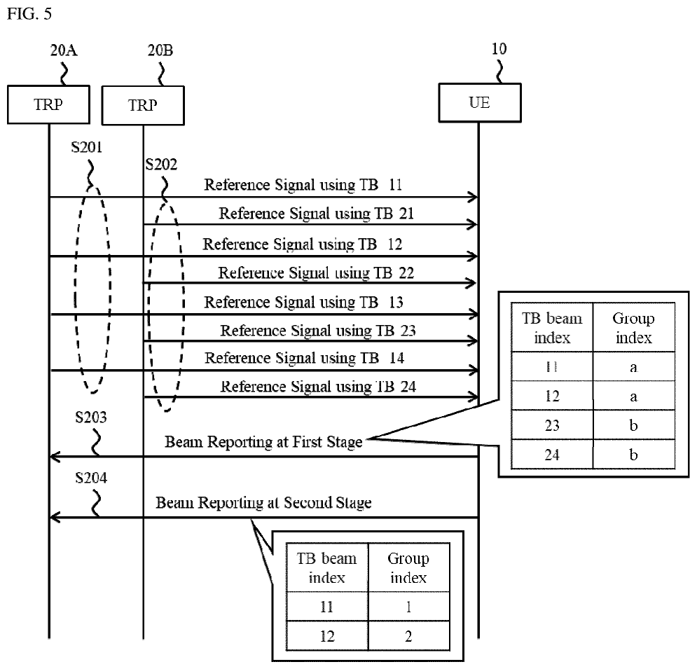

In the beam grouping type “Type 1” according to one or more embodiments of the present invention, multiple TBs simultaneously received at the UE 10 may be divided into the same group. For example, as shown in FIG. 4A, when the UE 10 simultaneously receives the TB 11 from the TRP 20A and the TBs 23 and 24 from the TRP 20B using the RB a1 and RB b1, the TBs 11, 23, and 24 may be divided into the same group, in which the same group index (e.g., group index “1”) is assigned. In an example of FIG. 4A, the UE 10 receives the TB 12 using at least one of the RB a2 and RB b2; therefore, the group index “2” for the TB 12 may be assigned. The UE 10 may perform the beam reporting that indicates beam information as shown in FIG. 4A.

Thus, in Type 1 according to one or more embodiments, different TBs reported for the same group may be received simultaneously at the UE 10. For example, by default for Type 1, different TBs reported for different groups cannot be received simultaneously at the UE 10.

(Type 2)

In the beam grouping type “Type 2” according to one or more embodiments of the present invention, multiple TBs simultaneously received at the UE 10 may be divided into different groups. For example, as shown in FIG. 4B, when the UE 10 receives the TBs 11 and 12 from the TRP 20A and the TBs 23 and 24 from the TRP 20B, the TBs 11 and 12 and the TBs 23 and 24 may be divided into the different groups, in which the different group indexes (e.g., group index “a” for the TBs 11 and 12 and group index “b” for the TBs 23 and 24) are assigned. In an example of FIG. 4B, the UE 10 may receive the TB 12 and the TB 11 using at least one of the RB a1 and the RB a2; therefore, the group index “a” for the TBs 11 and 12 may be assigned. The UE 10 may receive the TBs 23 and 24 using at least one of the RB b1 and the RB b2, therefore, the group index “b” for the TBs 23 and 24 may be assigned. The UE 10 may perform the beam reporting that indicates beam information as shown in FIG. 4B.

Thus, in Type 2 according to one or more embodiments of the present invention, different TBs reported for different groups may be received simultaneously at the UE 10. For example, by default for Type 2, different TBs reported for the same group cannot be received simultaneously at the UE 10

(Type 3)

Similar to Type 1, in the beam grouping type “Type 3” according to one or more embodiments of the present invention, multiple TBs simultaneously received at the UE 10 may be divided into the same group. For example, in Type 3, the TRP 20 may assume that the UE 10 does not simultaneously receive the TBs belonging to different groups and select at least a proper beam using the received beam reporting based on the assumption.

In Type 3 according to one or more embodiments of the present invention, different TBs reported for the same group can be received simultaneously at the UE 10. In Type 3, the TRP 20 cannot make any assumption on simultaneous reception of different TBs at the UE 10 reported for different groups.

(Type 4)

Similar to Type 2, in the beam grouping type “Type 4” according to one or more embodiments of the present invention, multiple TBs simultaneously received at the UE 10 may be divided into different groups. For example, in Type 4, the TRP 20 may assume that the UE 10 does not simultaneously receive different TBs belonging to the same group and select at least a proper beam using the received beam reporting based on the assumption.

In Type 4 according to one or more embodiments of the present invention, different TBs reported for different groups can be received simultaneously at the UE 10. In Type 4, the TRP 20 cannot make any assumption on simultaneous reception of different TBs reported for the same group. FIG. 2 is a table showing an example of a Tx Beam (TB) beam index and a Group index for reporting in a first step of Type 4 according to one or more embodiments of the present invention. FIG. 3 is a table showing an example of a TB beam index and a Group index for reporting of group a, with grouping Type 1 according to one or more embodiments of the present invention.

(Type 5)

Similar to Type 1, in the beam grouping type “Type 5” according to one or more embodiments of the present invention, multiple TBs simultaneously received at the UE 10 may be divided into the same group. Furthermore, in Type 5, different TBs simultaneously received at the UE 10 in each group may be divided into different sub-groups. For example, as shown in FIG. 4C, when the UE 10 simultaneously receives the TBs 11, 23 and 24 from the TRP 20B, the TBs 11, 23, and 24 may be divided into the same group. The TBs 11, 23, and 24 may be further divided into sub-groups

In Type 5 according to one or more embodiments of the present invention, different TBs reported for the same group can be received simultaneously at the UE 10. According to one or more embodiments of the present invention, within each group, different TBs reported for different sub-groups can be received simultaneously at the UE 10.

(Type 6)

Similar to Type 2, in the beam grouping type “Type 6” according to one or more embodiments of the present invention, multiple TBs simultaneously received at the UE 10 may be divided into different groups. Furthermore, in Type 6, different TBs simultaneously received at the UE 10 in each group may be divided into the same sub-groups. For example, as shown in FIG. 4D, when the UE 10 simultaneously receives the TBs 11, 23 and 24 from the TRP 20B, the TB 11 and the TBs 23 and 24 may be divided into the different groups. The TBs 11, 23, and 24 may be further divided into the same sub-group.

In Type 5 according to one or more embodiments of the present invention, different TBs reported for different groups can be received simultaneously at the UE 10. According to one or more embodiments of the present invention, within each group, different TBs reported for the same sub-group can be received simultaneously at the UE 10.

Beam reporting schemes according to one or more embodiments will be described below. In one or more embodiments, there are Schemes 1 to 3 as the beam reporting schemes in which measurement in the UE 10 may be performed based on the same set of RS resources.

(Scheme 1)

According to one or more embodiments of the present invention, independent single-shot beam reporting may be performed. For example, the UE 10 may report all combinations of the TB beam index and the group index in a single shot as the beam reporting.

(Scheme 2)

According to one or more embodiments of the present invention, independent multi-shot reporting may be performed. For example, the UE 10 may report all combinations of the TB beam index and the group index in multiple shots that do not depend on each other.

(Scheme 3)

According to one or more embodiments of the present invention, dependent multi-shot reporting may be performed. For example, the UE 10 may report all combinations of the TB beam index and the group index in multiple shots that depend on each other.

In an example of Scheme 3, the later reporting depends on the content of the previous beam reporting, without an additional indication from the TRP 20 to the UE 10. FIG. 5 is a sequence diagram showing an example of an operation of beam reporting according to one or more embodiments. Steps S201 and S202 in FIG. 5 are similar to steps S101 and S102 in FIG. 3, respectively. As shown in FIG. 5, at step S203, the UE 10 may perform beam reporting at a first stage. For example, at step S203, the beam reporting includes the TB beam index associated with the group index. For example, at step S203, the TB beam indexes may be divided into groups based on the beam grouping type “Type 4.” Then, at step S204, the UE 10 may perform beam reporting at a second stage. For example, the beam reporting at the second stage includes part of the TBs associated with the group index. For example, at step S204, the TB beam indexes may be divided into groups based on the beam grouping type “Type 1.” The above beam reporting scheme may support multi-stage beam group reporting.

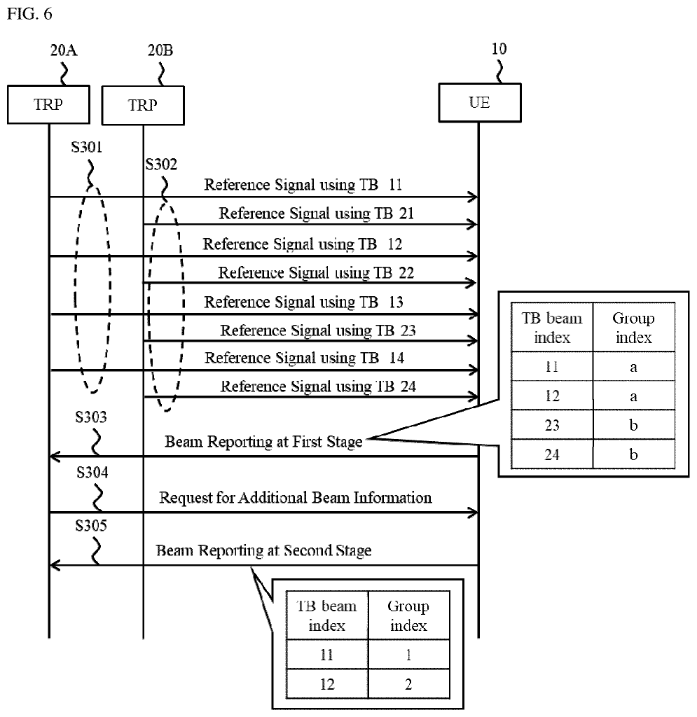

In another example of Scheme 3, based on the previous reporting, the TRP 20 may request additional reporting or configures of the later reporting. FIG. 6 is a sequence diagram showing another example of an operation of beam reporting according to one or more embodiments. Steps S301 to S303 in FIG. 6 are similar to steps S201 to S203 in FIG. 5, respectively. As shown in FIG. 6, at step S304, the TRP 20A may transmit a request for additional beam information after the TRP 20A receives the beam reporting at the first stage. At step S305, the UE 10 may perform beam reporting at a second stage based on reception of the request for the additional beam information. For example, step S305 is similar to step S204 in FIG. 5, respectively. The above scheme may support multi-stage beam group reporting.

Details of TRP 20 triggering for UE 10 beam reporting according to one or more embodiments of the present invention will be described blow.

(Tx Beams)

As Option 1 for TBs, all TBs may be measured and reported by the UE 10. In Option 1, explicit signaling from the TRP 20 to the UE 10 may not be needed.

As Option 2 for TBs, a subset of TBs may be measured and reported by the UE 10. For example, the subset of TBs may be reported in accordance with the previous Tx beam reporting.

(Rx Beams/Beam Groups)

As Option 1 for RBs/beam groups, the UE selection of RBs/beam groups may be performed. In this option, for example. explicit signaling from the TRP 20 to the UE 10 may not be needed.

As Option 2 for RBs/beam groups, RBs/beam groups may be indicated (e.g., according to previous Rx beam/beam group reporting).

(Grouping Types)

As Option 1 for grouping types, the UE selection of grouping types may be arbitrarily performed.

As Option 2 for grouping types, a single type for reporting may be indicated as the indication from the TRP 20.

As Option 3 for grouping types, a set of types may be indicated as the indication from the TRP 20 and the UE 10 may report the selected type.

A method of determining the UE beam grouping type according to one or more embodiments of the present invention will be described blow.

According to one or more embodiments, the beam grouping type may be specified based on e.g., UE capability. For example, when the UE 10 includes a single panel 100, Type 1 may be used as the beam grouping type. For example, when the UE 10 includes multiple panels 100, the UE 10 may perform the beam reporting that indicates one beam in each of multiple panels 100 and use Type 2 as the beam grouping type.

According to one or more embodiments, the TRP 20 may designate one or more beam grouping types used for the beam reporting based on the UE capability that indicates the number of panels 100 of the UE 10. The UE 10 may perform the beam reporting based on the beam grouping type.

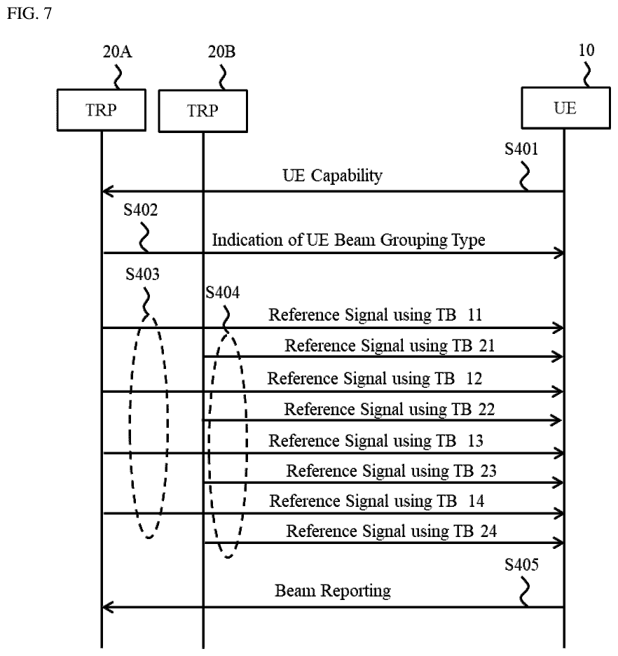

For example, as shown in FIG. 7, at step S401, the UE 10 may transmit UE capability that indicates the number of beams in each panel 100 to the TRP 20A. The UE capability may include the number of panels 100 of the UE 10.

At step S402, the TRP 20 may transmit an indication that designates a single beam grouping type (e.g., Type 5) to the UE 10. The TRP 20 may determine the beam grouping type based on the received UE capability.

Steps S403 and S404 are similar to steps S101 and S102, respectively. At step S405, the UE 10 may perform the beam reporting based on the beam grouping type designated in the indication.

Thus, the TRP 20 may configure the UE 10 to perform the beam reporting based on Type 5 only.

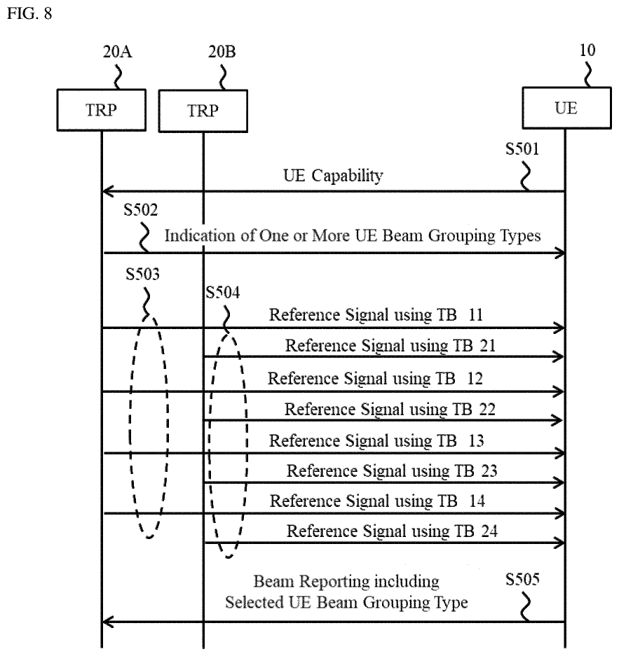

As another example, for example, as shown in FIG. 8, at step S501, the UE 10 may transmit UE capability that indicates the number of beams in each panel 100 to the TRP 20A.

At step S402, the TRP 20 may transmit an indication that designates one or more beam grouping types to the UE 10. The TRP 20 may determine the beam grouping types based on the received UE capability.

Steps S503 and S504 are similar to steps S101 and S102, respectively. The UE 10 may select a beam grouping type used for the beam reporting from the one or more beam grouping types. At step S505, the UE 10 may perform the beam reporting including the selected beam grouping type in addition to the beam information. The selected beam grouping type may be reported to the TRP 20 in a separate signal different from the beam reporting.

Thus, the TRP 20 may configure the UE 10 to report the UE beam grouping type from a set {1, 2, 3, 4} (Types 1-4) in each reporting slot.

In examples of FIGS. 7 and 8, the indication that indicates beam grouping type may be transmitted semi-statically (e.g., Radio Resource Control (RRC) signaling) or dynamically (e.g., Medium Access Control (MAC) Control Element (CE) or Downlink Control Information (DCI)).

Embodiments of first to fourth examples of operations of the multi-stage beam group reporting will be described below. In one or more embodiments of the first to fourth examples of the present invention, the TRP configuration includes “TBs,” “RBs/beam groups,” and “Beam grouping type” and the beam reporting from the UE 10 includes “Beam grouping type.”

### First Example

According to one or more embodiments of the first example of the present invention, at a first stage, in the indication notified from the TRP 20, “TBs,” “RBs/beam groups,” and “Beam grouping type” may be set as “all,” “all,” and “all,” respectively. In the beam reporting from the UE 10, “Beam grouping type” may be set as “Type 1/2/5/6.” The indication notified from the TRP 20 may be referred to as a TRP configuration.

In the first example, at a second stage, the TRP 20 may not transmit, to the UE 10, the indication to acquire further beam information.

### Second Example

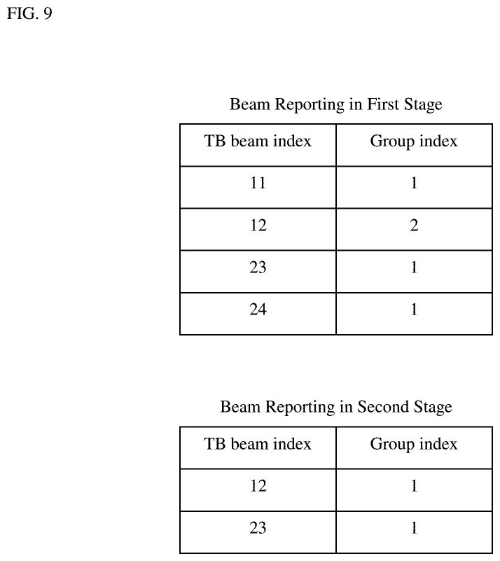

According to one or more embodiments of the second example, at a first stage, in the indication notified from the TRP 20, “TBs,” “RBs/beam groups,” and “Beam grouping type” may be set as “all,” “all,” and “all,” respectively. In the beam reporting from the UE 10, “Beam grouping type” may be set as “Type 3.” As shown in FIG. 9, “11”, “12”, “23”, and “24” are set in the TB beam index and correspond to “1”, “2”, “1”, and “1” in the Group index, respectively. The TB beam indexes “11”, “23”, and “24” can be received simultaneously. On the other hand, it is not clear whether the TB beam indexes “12” and “23” can be received simultaneously at the first stage.

At a second stage, in the indication notified from the TRP 20, “TBs” and “Beam grouping type” may be set as “12 and 23” and “Type 3,” respectively. In the second stage, “RBs/beam groups” may be omitted. As shown in FIG. 9, “12” and “23” are set in the TB beam index and correspond to “1” and “1” in the Group index, respectively. As a result, the TB beam indexes “12” and “23” can be received simultaneously.

### Third Example

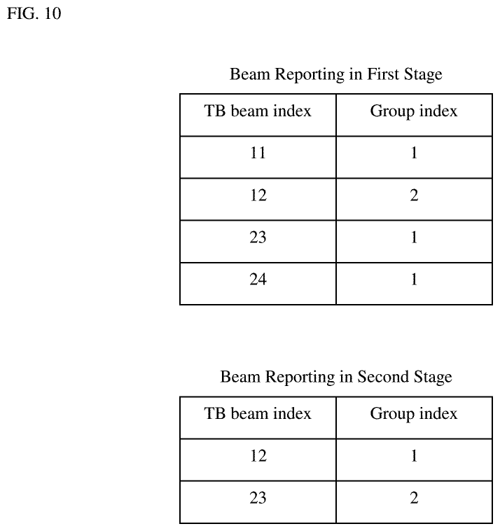

According to one or more embodiments of the third example, at a first stage, in the indication notified from the TRP 20, “TBs,” “RBs/beam groups,” and “Beam grouping type” may be set as “all,” “all,” and “all,” respectively. In the beam reporting from the UE 10, “Beam grouping type” may be set as “Type 3.” As shown in FIG. 10, “11”, “12”, “23”, and “24” are set in the TB beam index and correspond to “1”, “2”, “1”, and “1” in the Group index, respectively. The TB beam indexes “11”, “23”, and “24” can be received simultaneously. On the other hand, it is not clear whether the TB beam indexes “12” and “23” can be received simultaneously at the first stage.

At a second stage, in the indication notified from the TRP 20, “TBs” and “Beam grouping type” may be set as “12 and 23” and “Type 4,” respectively. In the second stage, “RBs/beam groups” may be omitted. As shown in FIG. 10, “12” and “23” are set in the TB beam index and correspond to “1” and “2” in the Group index, respectively. As a result, the TB beam indexes “12” and “23” can be received simultaneously.

### Fourth Example

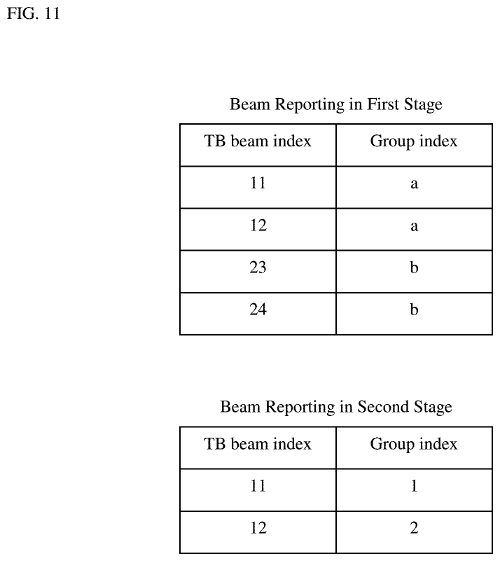

According to one or more embodiments of the fourth example, at a first stage, in the indication notified from the TRP 20, “TBs,” “RBs/beam groups,” and “Beam grouping type” may be set as “all,” “all,” and “all,” respectively. In the beam reporting from the UE 10, “Beam grouping type” may be set as “Type 4.” As shown in FIG. 11, “11”, “12”, “23”, and “24” are set in the TB beam index and correspond to “a”, “a”, “b”, and “b”, respectively. The TB beam indexes “11/21” and “23” can be received simultaneously. On the other hand, it is not clear whether the TB beam indexes “11” and “12” can be received simultaneously at the first stage.

At second stage, in the gNB (TRP) configuration, “RBs/beam groups” and “Beam grouping type” may be set as “1” and “Type 3,” respectively. In the second stage, “TBs” may be omitted. As shown in FIG. 11, “11” and “12” are set in the TB beam index and correspond to “1” and “2” in the Group index, respectively. As a result, the TB beam indexes “11” and “12” can be received simultaneously.

Compared to conventional scheme, which can provide good performance in one scenario (e.g., one hardware configuration) but have non-optimal performance in another scenario, one or more embodiments of the present invention can provide signaling flexibility to adapt different reporting types for different scenarios. Compared to conventional single stage feedback scheme, which cannot achieve the best balance between performance and feedback overhead, by introducing a multi-stage feedback scheme, one or more embodiments of the present invention can achieve same performance with less feedback overhead.

One or more embodiments of the present invention may be used for the TRP 20 to obtain reliable channel state information/beam(s) state information to optimize beamforming and scheduling to provide high data rates and high reliability service.

(Configuration of TRP)

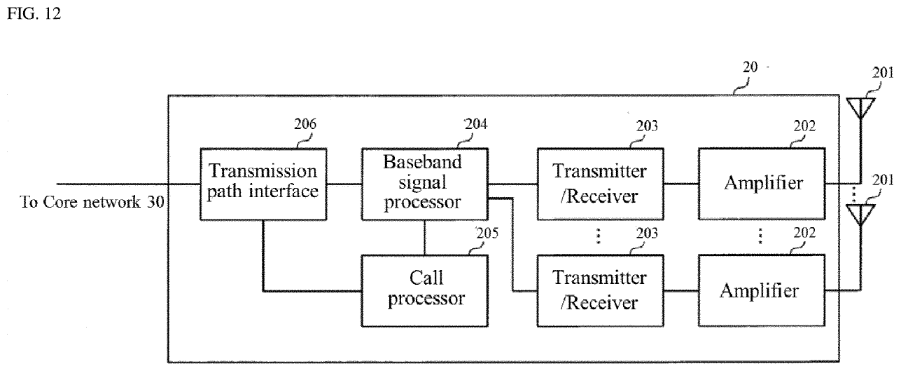

The TRP 20 according to one or more embodiments of the present invention will be described below with reference to FIG. 12. FIG. 12 is a diagram illustrating a schematic configuration of the TRP 20 according to one or more embodiments of the present invention. The TRP 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the TRP 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., RRC signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the TRP 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the TRP 20, and manages the radio resources.

(Configuration of UE)

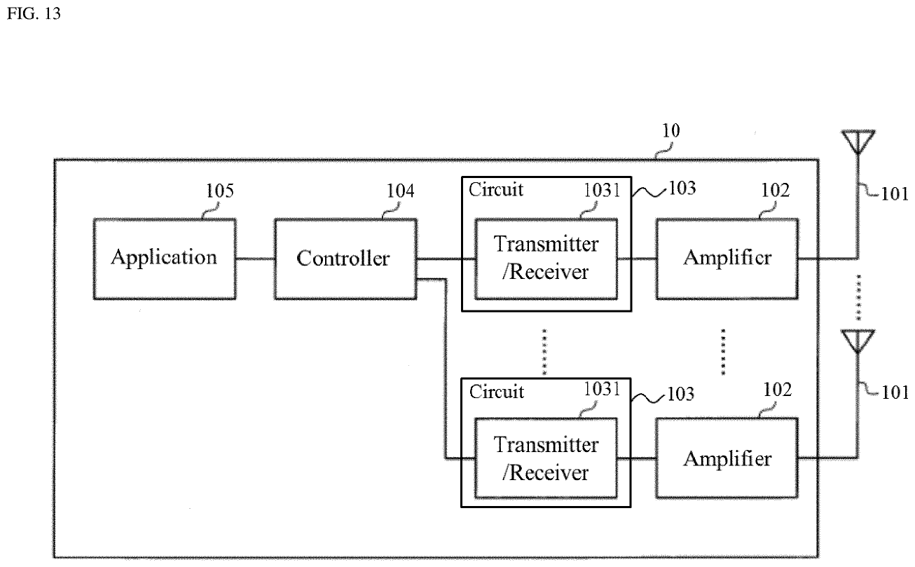

The UE 10 according to one or more embodiments of the present invention will be described below with reference to FIG. 13. FIG. 13 is a schematic configuration of the UE 10 according to one or more embodiments of the present invention. The UE 10 has a plurality of UE antennas 101, amplifiers 102, the circuit 103 comprising transceiver (transmitter/receiver) 1031, the controller 104, and an application 105.

As for DL, radio frequency signals received in the UE antennas 101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

One or more embodiments of the present invention may be used for each of the uplink and the downlink independently. One or more embodiments of the present invention may be also used for both of the uplink and the downlink in common.

Although the TRP 20A and the TRP 20B transmits the RSs using the TBs 11-14 and the TBs 21-24, respectively, in FIGS. 3 and 5-8, the TBs 21-24 may be transmitted from another panel 200 of the TRP 20A. As another example, the TBs 11-14 may be transmitted from another panel 200 the TRP 20B.

Although the present disclosure mainly described examples of a channel and signaling scheme based on NR, the present invention is not limited thereto. One or more embodiments of the present invention may apply to another channel and signaling scheme having the same functions as NR such as LTE/LTE-A and a newly defined channel and signaling scheme.

Although the present disclosure mainly described examples of various signaling methods, the signaling according to one or more embodiments of the present invention may be explicitly or implicitly performed.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method of performing beam reporting in a wireless communication system, the method comprising:
receiving, with a user equipment (UE), multiple Transmission (Tx) beams used for transmission of reference signals (RSs) from a base station (BS); and
performing, with the UE, first beam reporting to the BS,
wherein the first beam reporting indicates the Tx beams divided into groups based on a first predetermined grouping type.

2. The method according to claim 1,
wherein the receiving simultaneously receives first Tx beams of the multiple Tx beams, and
wherein the first Tx beams are divided into a same group based on the first predetermined grouping type.

3. The method according to claim 1,
wherein the receiving simultaneously receives first Tx beams of the multiple Tx beams, and
wherein the first Tx beams are divided into different groups based on the first predetermined grouping type.

4. The method according to claim 2, further comprising:
assuming, with the BS, that the UE does not simultaneously receive the Tx beams belonging to different groups; and
selecting, with the BS, at least a Tx beams from the Tx beams indicated in the beam reporting based on the assumption.

5. The method according to claim 3, further comprising:
assuming, with the BS, that the UE does not simultaneously receive the Tx beams belonging to a same group; and
selecting, with the BS, at least a Tx beams from the Tx beams indicated in the beam reporting based on the assumption.

6. The method according to claim 2, wherein the first Tx beams in the same group are divided into different sub-groups.

7. The method according to claim 3, wherein the first Tx beams in each of the different groups are divided into different sub-groups.

8. The method according to claim 1, further comprising:
performing, with the UE, second beam reporting to the BS after performing the first beam reporting,
wherein the second beam reporting indicates part of the Tx beams divided into groups based on a second predetermined grouping type.

9. The method according to claim 8, further comprising:
transmitting, from the BS to the UE, a request for the second beam reporting based on the BS receiving the first beam reporting,
wherein the performing performs the second beam reporting based on the UE receiving the request.

10. The method according to claim 1, further comprising:
specifying, with the UE, the first predetermined grouping type based on a number of panels of the UE.

11. The method according to claim 1, further comprising:
notifying, with the UE, the BS of UE capability; and
transmitting, from the BS to the UE, an indication that designates the first predetermined grouping type determined based on the UE capability.

12. The method according to claim 11, wherein the UE capability indicates a number of panels of the UE.

13. The method according to claim 1, further comprising:
notifying, with the UE, the BS of UE capability;
transmitting, from the BS to the UE, an indication that designates one or more grouping types determined based on the UE capability.

14. The method according to claim 13, further comprising:
selecting, with the UE, the first predetermined grouping type from the one or more grouping types; and
reporting, from the UE to the BS, the selected first predetermined grouping type.

15. The method according to claim 13, wherein the UE capability indicates a number of panels of the UE.

16. A user equipment (UE) comprising:
a receiver that receives multiple Transmission (Tx) beams used for transmission of reference signals (RSs) from a base station (BS); and
a transmitter that performs, first beam reporting to the BS,
wherein the first beam reporting indicates the Tx beams divided into groups based on a first predetermined grouping type.

17. The UE according to claim 16,
wherein the receiver simultaneously receives first Tx beams of the multiple Tx beams, and
wherein the first Tx beams are divided into a same group based on the first predetermined grouping type.

18. The UE according to claim 16,
wherein the receiver simultaneously receives first Tx beams of the multiple Tx beams, and
wherein the first Tx beams are divided into different groups based on the first predetermined grouping type.

19. The UE according to claim 16,
wherein the transmitter transmits second beam reporting to the BS after the transmitter performs the first beam reporting, and
wherein the second beam reporting indicates part of the Tx beams divided into groups based on a second predetermined grouping type.

20. The UE according to claim 19,
wherein the receiver receives, from the BS, a request for the second beam reporting, and
wherein the transmitter performs the second beam reporting based on the receiver receiving the request.
